(19) United States
(12) Patent Application Publication
(10) Pub. No.: US 2006/0243809 A1
(43) Pub. Date: Nov. 2, 2006

(54) Combination logo and identification code

(76) Inventors: Rodney T. Hodgson, Ossining, NY (US); David Bear, Wellesley, MA (US)

Correspondence Address: SUTHERLAND ASBILL & BRENNAN LLP, 999 PEACHTREE STREET, N.E., ATLANTA, GA, 30309, US

(21) Appl. No.: 11/131,300

(22) Filed: Apr. 27, 2005

(51) Int. Cl. G06K 19/00; G06K 19/06

(52) U.S. Cl. 235/487; 235/494

(57) ABSTRACT

Indicia forming a logo is encoded with a unique identification code.

### RELATED PATENTS AND APPLICATIONS

This patent is related to: U.S. application Ser. No. 11/081960, filed Mar. 16, 2005; U.S. application Ser. No. 10/935,506 filed Sep. 7, 2004; U.S. application Ser. No. 10/961,925, filed Oct. 9, 2004; U.S. application Ser. No. 10/890,725; and U.S. application Ser. No. 10/890,725, filed Jul. 14, 2004. The above applications are assigned to the assignee of the present invention, and are hereby incorporated by reference.

### FIELD OF THE INVENTION

The field of the invention is the field of article identification and provenance.

### BACKGROUND OF THE INVENTION

Counterfeiting and diversion of articles and drugs is a major problem. Attachment of unique identifying codes to articles and drugs has been suggested as a way to control such diversions.

### OBJECTS OF THE INVENTION

It is an object of the invention to produce an apparatus and a method of attaching a unique identifying code to an object such that, if the code is destroyed, so also is a logo or other identifying indicia identifying the object.

### SUMMARY OF THE INVENTION

An object having indicia forming a logo has a unique identification code encoded within the indicia.

### DETAILED DESCRIPTION OF THE INVENTION

Application Ser. No. 10/890,725 and U.S. application Ser. No. 10/890,725 disclose an apparatus, method, and system for associating a unique identifying code with a batch of medication sufficient for a prescription. Preferably, the unique identifying code is attached to each pill, tablet, caplet, or capsule (all of which defined as “pills” in the present application) of the invention, or mixed into the material of such pills or liquid material prescribed.

In the above applications, the identifying code can be traced back to the particular patient who illegally diverts, loses, or has his or her pills stolen. Since the medication can be tracked, there is much more pressure on the patient not to sell or otherwise divert the pills from their prescribed use.

Unfortunately, an identifying code placed on each pill, for example by laser or ink jet marking, can be scraped off or otherwise defaced, and the deterrence reduced.

However, the pills are normally sold whole, as the customers insist that the pill be identifiable so that the dose, potency, and actual material are known. Thus, a pill is recognized by its size, shape, color, surface texture, and principally by a logo or other identifying indicia imprinted on the pill or stamped into the material of the pill.

The invention is thus to encode a unique identifying code into the actual indicia forming the logo of the pill. As an example, a pill with a coating containing TiO₂ can be written with an ultraviolet laser, which changes the white material to black. If the logo is written with the laser, a code can be incorporated into the logo just as a bar code (one dimensional or two dimensional) is written or printed on paper. An ink jet can write spots of 50 micron diameter, and a laser can write spots of 1 micron diameter. On a logo measuring 5 mm by 10 mm, the laser could write fifty million bits of information. Since a unique identifying code would rarely need more than 40 bits of information, the code could be written over and over, covering the entire surface of the logo, so that if a part of the logo was scraped away, enough of the logo would remain that it could be read.

It is important to note that the code need be read only very rarely, and the cost to read the code is not an issue. A code with micron resolution spots is not readable by the human eye, but is easily read under a high power microscope, if not with a normal bar code reader. In general, the logo is big enough to be read by the human eye.

Another even more secure way to encode a pill is to digitally produce and record a hologram of the bar code on the pill. The image of any portion of a hologram can be used to reconstruct the original bar code image. If the indicia forming the logo is defaced so that some parts are still legible, as would be required to see the logo, enough of the code will be left to be able to reconstruct the image of the bar code from the remaining bits of the logo. Preferably, the hologram or bar coding is written over a part of the indicia forming the logo. More preferably, the hologram covers the entire area of the logo.

Preferably, the hologram or two dimensional bar code appears uniform to the human eye. Bar codes can be made so that the reflectivity averaged over the distance resolved by the human eye will be constant over the logo.

One and two dimensional bar codes are very well known to one of skill in the art. They have been designed to be read under difficult conditions when scuffed and dirty, and hence degraded contrast and resolution which would accompany partial destruction of the hologram can be overcome. Preferably, the unique identification code is identifiable if less than 50% of the indicia is destroyed. More preferably, the unique identification code is identifiable if less than 90% of the indicia is destroyed.

The present invention is useful not only for pills, but for other objects which depend for their value on a logo attached or embedded in the object. Such objects, for example are articles of jewelry such as gemstones, diamonds or objects containing gold. Other objects which are often counterfeited, and for which the buyers rely on logos to ensure that the quality of the object meets specification are parts for machines like aircraft. Turbine blades are, in particular, very important and very expensive, especially if they fail and cause an engine to be destroyed. Articles of clothing and personal accessories are often counterfeited. Shoes, handbags, luggage, and watches, among other objects, rely for very much of their value on the logo. Medical devices and implants such as stents, pacemakers, artificial joints etc. are also anticipated by the inventors.

The logo is preferably firmly attached to the object to be protected, or the logo and identifying code is preferably written directly on to the object. A pulse laser making an identifying code or a hologram which can be translated into an identifying code can punch a series of pits into metal or leather, and the pattern on the surface changes the light reflectivity to allow the logo to be seen. In the pills, as discussed, the absorptivity of the surface and subsurface material is changed, so that the mark appears black or dark grey against the underlying white material.

Obviously, many modifications and variations of the present invention are possible in light of the above teachings. It is therefore to be understood that, within the scope of the appended claims, the invention may be practiced otherwise than as specifically described.

We claim:

1. An apparatus, comprising:
an object;
indicia forming a logo, the indicia associated with the object, and;
a unique identification code, wherein the unique identification code is encoded within the indicia.

2. The apparatus of claim 1, wherein the indicia is attached to the object.

3. The apparatus of claim 1, wherein the indicia is written on the object.

4. The apparatus of claim 1, wherein the indicia is written into to the object.

5. The apparatus of claim 1, wherein the unique identification code is identifiable if less than 50% of the indicia is destroyed.

6. The apparatus of claim 5, wherein the unique identification code is identifiable if less than 90% of the indicia is destroyed.

7. The apparatus of claim 1, wherein unique identification code is a holographic representation encoded over the entire area covered by the logo.

8. The apparatus of claim 1, wherein the logo is readable by the unaided human eye, and the unique identification code is unreadable by the unaided human eye.

9. The apparatus of claim 8, wherein the average density of the indicia forming the logo is uniform over a distance resolvable by the unaided human eye.

10. The apparatus of claim 1, wherein the object is a pill.

11. The apparatus of claim 1, wherein the object is an article of jewelry.

12. The apparatus of claim 11, wherein the object is a gemstone.

13. The apparatus of claim 12, wherein the object is a diamond.

14. The apparatus of claim 11, wherein the object contains gold.

15. The apparatus of claim 1, wherein the object is a part for a machine.

16. The apparatus of claim 15, wherein the object is a turbine blade.

17. The apparatus of claim 1, wherein the object is an article of clothing.

18. The apparatus of claim 17, wherein the object is a shoe.

19. The apparatus of claim 1, wherein the object is a personal accessory.

20. The apparatus of claim 19, wherein the object is a handbag.

21. The apparatus of claim 19, wherein the object is an article of luggage.

22. The apparatus of claim 19, wherein the object is a watch.
